(19) United States
(12) Patent Application Publication
(10) Pub. No.: US 2006/0080402 A1
(43) Pub. Date: Apr. 13, 2006

(54) Apparatus and method for socket communication between applications in operating system that does not support a process

(75) Inventors: Kuk-hyun Han, Suwon-si (KR); Jong-in Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/238,050

(22) Filed: Sep. 29, 2005

(30) Foreign Application Priority Data
Oct. 11, 2004 (KR) 10-2004-0080886

(51) Int. Cl. G06F 15/16

(52) U.S. Cl. 709/217

(57) ABSTRACT

An apparatus and method are provided for socket communication between applications in an operating system that does not support a process. The apparatus includes a server socket interface and a client socket interface. The server socket interface is created by the server application and has a first name. The client socket interface is created by the client application and has a second name that is related to the first name. The server socket interface includes a server message queue having the first name. The client socket interface includes a client message queue having the second name. The server message queue and the client message queue perform message queue-based communication between the server application and the client application.

### BACKGROUND OF THE INVENTION

This application claims priority from Korean Patent Application No. 10-2004-0080886, filed on Oct. 11, 2004, in the Korean Intellectual Property Office, the disclosure of which is incorporated herein in its entirety by reference.

1. Field of the Invention

Apparatuses and method consistent with present invention which relate to socket communication between applications, and more particularly, to name-based socket communication between applications in an operating system (OS) that does not support a process.

2. Description of the Related Art

To avoid dependence on operating systems, software is designed such that abstraction layers for main functions offered by the operating systems are first implemented and desired applications then operate using only the implemented abstraction layers. In other words, to allow an application to operate in various types of operating systems, all that needs to be done is to extract main functions required for the application, implement an abstraction layer for the extracted main functions, and redesign the implemented abstraction layer to fit the new operating system (while maintaining existing interfaces).

However, if the new operating system does not provide functions required for the application, it is impossible to maintain the existing interfaces. For example, in the case of name-based socket communication, which is widely used as a method of communication between processes, when it is desired that an application be allowed to operate in an operating system that does not support a process, name-based socket communication is not available. In this case, a method of communication in the application should be changed. This is because the operating system that does not support the process supports Internet protocol (IP)-based socket communication but not name-based socket communication.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides an apparatus and method for socket communication, in which name-based socket communication interfaces can be maintained in an operating system that does not support a process.

According to one aspect of the present invention, there is provided an apparatus for socket communication between a server application and a client application in an operating system that does not support a process. The apparatus comprises a server socket interface and a client socket interface. The server socket interface is created by the server application and has a first name. The client socket interface is created by the client application and has a second name that is related to the first name. The server socket interface includes a server message queue having the first name. The client socket interface includes a client message queue having the second name. The server message queue and the client message queue perform message queue-based communication between the server application and the client application.

Here, socket communication from the server application to the client application is performed such that the server message queue stores client data indicating data required by the client application in response to a sending command from the server application, and the client application obtains the client data from the sever message queue using a reception command.

Also, socket communication from the client application to the server application is performed such that the client message queue stores server data indicating data required by the server application in response to a sending command from the client application, and the server application obtains the server data from the client message queue using a reception command.

According to another aspect of the present invention, there is provided a method for socket communication between a server application and a client application in an operating system that does not support a process. The method comprises creating a server socket interface having a first name and a server message queue having the first name in the server socket interface, in response to a server socket interface creation command from the server application, and creating a client socket interface having a second name that is related to the first name and a client message queue having the second name in the client socket interface, in response to a connection command from the client application for connection to the server socket interface. The server message queue and the client message queue perform message queue-based communication between the server application and the client application.

### BRIEF DESCRIPTION OF THE DRAWINGS

The above aspects of the present invention will become more apparent by describing in detail exemplary embodiments thereof with reference to the attached drawings in which:

FIG. 1 illustrates a hierarchical structure of software for allowing an application to operate;

FIG. 2 illustrates name-based socket communication;

FIG. 3 is a block diagram of an apparatus for socket communication according to an exemplary embodiment of the present invention; and

FIG. 4 is a flowchart illustrating a method for socket communication according to an exemplary embodiment of the present invention.

### DETAILED DESCRIPTION OF EXEMPLARY EMBODIMENTS OF THE INVENTION

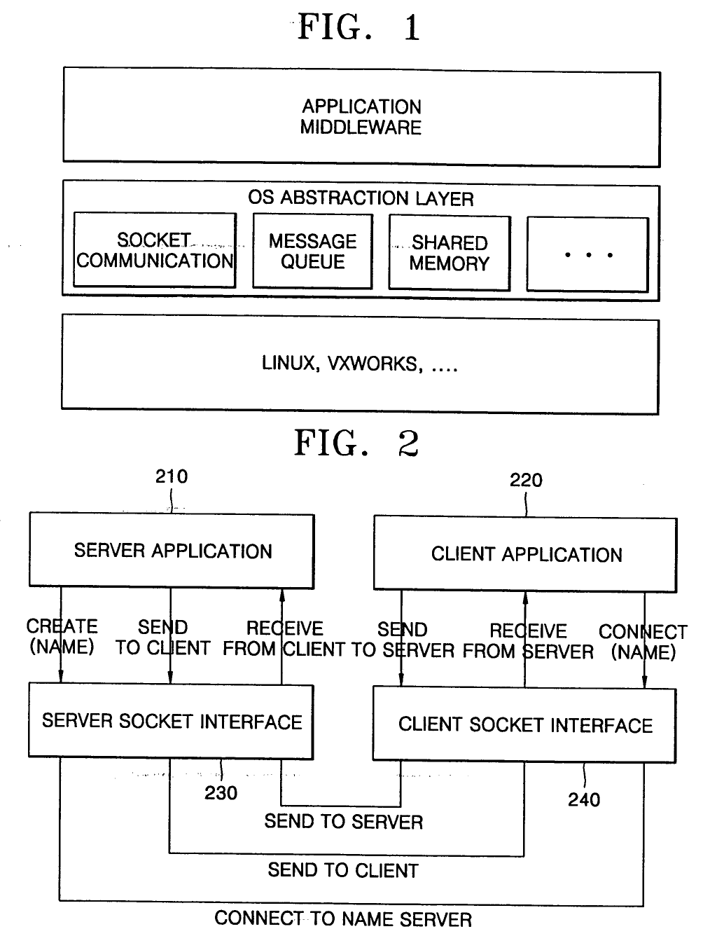

FIG. 1 illustrates a hierarchical structure of software for allowing an application to operate.

As the functions of embedded systems become more diversified and are scaled up, the use of operating systems (OSs) has become essential in embedded systems and OS selection has become diversified to match the characteristics of embedded systems. In implementing an embedded system, OS selection is not only a starting point, but also an important factor that determines the performance of the embedded system. However, due to diversity in the characteristics of embedded systems and OSs, a rule specifying a particular OS as being suitable for a specific system cannot be applied in all cases.

Application models include a process-based model, which is operable in an OS that supports a process, and a thread-based model, which is operable in an OS that does not support a process. The process-based model is designed such that each OS kernel or application operates independently and memories of applications are protected against each other. As a result, the process-based model facilitates development of application programs or addition of modules, and allows for development of stable systems. Therefore, the process-based model is suitable for development of large-scale systems.

On the other hand, the thread-based model is designed such that an OS kernel and an application program are implemented as one program without a distinction therebetween. In the thread-based model, a shared memory is freely accessible and the size of an OS is small. Also, the thread-based model can be easily and rapidly implemented.

As embedded systems such as digital TVs become more sophisticated and the characteristics of each consumer electronics (CE) family become more complicated, applied OSs are also diversified. Thus, even when it is not necessary to modify the entire system due to a change in an OS, all software (S/W) including application programs should be changed and implemented again.

To this end, embedded S/W structures and methodologies that allow for rapid reconfiguration of a system by abstracting a portion to be changed due to a change in an OS have been proposed. An example of such a proposal is implementation of abstraction layers.

As shown in FIG. 1, to exclude a direct connection between an application and an OS, an OS abstraction layer (OSAL) is added to an S/W structure. The OSAL enables reuse of upper S/W in the case of a change in the OS and includes main functions required for the application.

The OSAL can modify and use an OS without changing upper application programs and middleware (M/W), by providing application programming interfaces (API) that are abstracted with respect to changed components of the OS. In other words, as shown in FIG. 1, a common API is provided to each kernel component offered by each OS and an upper application program uses the common API to access the OS.

Once S/W is implemented using such an OSAL, it is possible to migrate the entire S/W by changing the OSAL without changing a verified S/W module when an OS changes. However, when the OS does not support a corresponding function, the OS cannot be changed with only modification to the OSAL. Thus, it is necessary to additionally implement the corresponding function by maintaining the API of an OS that supports the corresponding function. In particular, when changing the process-based model to the thread-based model, it is necessary to implement functions, such as communication between processes, which are not provided by thread-based OSs.

FIG. 2 illustrates name-based socket communication.

A server application 210 and a client application 220 desire to communicate.

The server application 210 communicates with the client application 220, for example, in the following cases.

It is assumed that applications operate such that after causing a table of channel numbers and programs being currently played on those channels to be displayed on a screen of a TV, a user selects a channel from the displayed table causing a program corresponding to the selected channel to be displayed on the TV. In this case, two applications, i.e., a table application for displaying the table and a play application for displaying the program corresponding to the selected channel, are required. Since the table application should be executed before the play application, certain information (in this case the channel number selected by the user) created in the table application should be delivered to the play application. Thus, the table application serves as the client application 220, the play application serves as the server application 210, and the channel number serves as server data required by the server application 210.

The server application 210 creates a server socket interface 230 using a server socket interface creation command “create NAME” having a predetermined name. The server socket interface 230 is created in an OSAL. The created server socket interface 230 stands by until accessed by a client socket interface 240.

The client application 220 creates the client socket interface 240 and delivers a connection command “connect NAME” to the client socket interface 240. The client socket interface 240 attempts to connect to the server socket interface 230 based on the name of a server interface to be connected, thereby completing a socket connection between the server socket interface 230 and the client socket interface 240.

Once socket connection is completed, the server application 210 or the client application 220 can transmit packets using a sending function “send” or receive packets using a reception function “receive”, at a desired time.

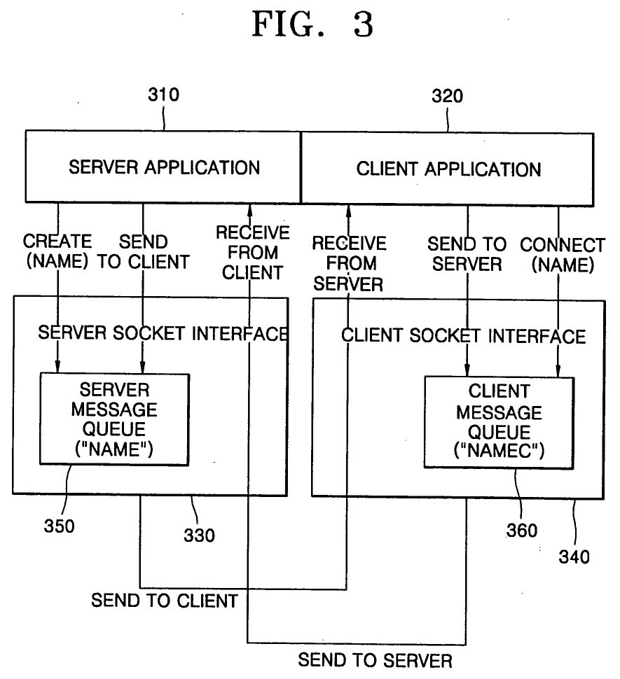

FIG. 3 is a block diagram of an apparatus for socket communication according to an exemplary embodiment of the present invention.

The apparatus for socket communication according to an exemplary embodiment of the present invention includes a server socket interface 330 and a client socket interface 340. The server socket interface 330 includes a server message queue 350 and the client socket interface 340 includes a client message queue 360.

The server socket interface 330 is created in response to the server socket interface creation command “create NAME” from the server application 310, and includes the server message queue 350 having the same name as the server socket interface 330.

The client socket interface 340 is created in response to the connection command “connect NAME” from a client application 320 for connection to the server application 310, and includes the client message queue 360. The name of client socket interface 340 and the client message queue 360 are created such that they have a relationship with the name of the server socket interface 330 to be connected to. The name relationship is established according to a predetermined rule. For example, according to a predetermined rule, when a server message queue has the name “NAME”, a client message queue having the name “NAMEC” is created. The server application 310 and the client application 320 should recognize the name creation rule so that they can correctly request desired data.

Once the server socket interface 330, the client socket interface 340, the server message queue 350, and the client message queue 360 are created, the server application 310 and the client application 320 can communicate with each other.

First, socket communication from the server application 310 to the client application 320 is performed according to a message queue-based communication method using the server message queue 350. The message queue-based communication method is well known to those skilled in the art. Since the name of a message queue is created according to a predetermined rule between a server and a client, if applications recognize the rule, communication can proceed using the message queue.

In other words, socket communication from the server application 310 to the client application 320 is performed such that the server message queue 350 stores client data indicating data required by the client application 320 in response to a sending command “send” from the server application 310, and the client application 320 obtains the client data from the server message queue 350 using a reception command “receive”.

Next, socket communication from the client application 320 to the server application 310 is done according to a message queue-based communication method using the client message queue 360.

In other words, socket communication from the client application 320 to the server application 310 is performed such that the client message queue 360 stores server data indicating data required by the server application 310 in response to the sending command “send” from the client application 320, and that the server application 310 obtains the server data from the client message queue 360 using the reception command “receive”.

Since a message queue function can be implemented in an OS that does not offer a name-based socket communication function, a server application and a client application outwardly appear to be performing name-based socket communication using a message queue. Thus, by changing an internal configuration of a socket interface that exists in an OSAL without changing applications, the applications that could perform name-based socket communication only in an OS that supports a process can perform name-based socket communication even in an OS that does not support a process.

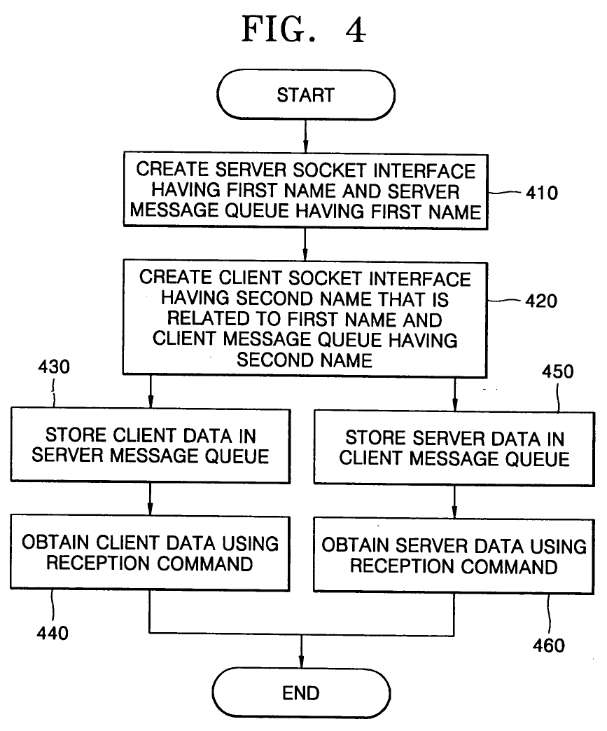

FIG. 4 is a flowchart illustrating a method of socket communication according to an exemplary embodiment of the present invention.

In operation 410, in response to a socket creation command “create” from the server application 310, the server socket interface 330 having a first name is created and the server message queue 350 having the same first name is created in the server socket interface 330.

In operation 420, in response to connection command “connect” from the client application 320 for connection to the server socket interface 330, the client socket interface 340 having a second name that is related to the first name of the server socket interface 330 is created, and the client message queue 360 having the same second name is created in the client socket interface 340.

In operations 430 through 460, the server application 310 and the client application 320 perform socket communication according to a message queue-based communication method using the server client message queue 350 and the client message queue 360.

In operations 430 and 440, socket communication from the server application 310 to the client application 320 is performed.

In operation 430, the server message queue 350 stores client data indicating data required by the client application 320 in response to the sending command “send” from the server application 310.

In operation 440, the client application 320 obtains the client data from the server message queue 350 using the reception command “receive”.

In operations 450 and 460, socket communication from the client application 320 to the server application 310 is performed.

In operation 450, the client message queue 360 stores server data indicating data required by the server application 310 in response to the sending command “send” from the client application 320.

In operation 460, the server application 310 obtains the server data from the client message queue 360 using the reception command “receive”.

As described above, according to an exemplary embodiment of the present invention, applications that could perform name-based socket communication only in an OS that supports a process can, by virtue of an exemplary embodiment of the present invention, perform name-based socket communication even in an OS that does not support a process.

Meanwhile, the method for socket communication according to an exemplary embodiment of the present invention can also be embodied as a computer-readable program on a computer-readable recording medium. Codes and code segments that form the program can be easily constructed by those skilled in the art, and the program can be stored in a computer-readable recording medium and read and executed by a computer to implement the method for socket communication. Examples of the computer-readable recording medium include magnetic tapes, optical data storage devices, and carrier waves.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for socket communication between a server application and a client application in an operating system that does not support a process, the apparatus comprising:
a server socket interface created by the server application and having a first name; and
a client socket interface created by the client application and having a second name that is related to the first name,
wherein the server socket interface comprises a server message queue having a name identical to the first name, the client socket interface comprises a client message queue having a name identical to the second name, and the server message queue and the client message queue perform message queue-based communication between the server application and the client application.

2. The apparatus of claim 1, wherein socket communication from the server application to the client application is performed such that the server message queue stores client data indicating data required by the client application in response to a sending command from the server application, and the client application obtains the client data from the server message queue using a reception command.

3. The apparatus of claim 1, wherein socket communication from the client application to the server application is performed such that the client message queue stores server data indicating data required by the server application in response to a sending command from the client application, and the server application obtains the server data from the client message queue using a reception command.

4. A method for socket communication between a server application and a client application in an operating system that does not support a process, the method comprising:
creating a server socket interface having a first name and a server message queue having a name identical to the first name in the server socket interface, in response to a server socket interface creation command from the server application; and
creating a client socket interface having a second name that is related to the first name and a client message queue having a name identical to the second name in the client socket interface, in response to a connection command from the client application for connection to the server socket interface,
wherein the server message queue and the client message queue perform message queue-based communication between the server application and the client application.

5. A computer-readable recording medium having embodied thereon a program for executing a method for socket communication between a server application and a client application in an operating system that does not support a process, the method comprising:
creating a server socket interface having a first name and a server message queue having a name identical to the first name in the server socket interface, in response to a server socket interface creation command from the server application; and
creating a client socket interface having a second name that is related to the first name and a client message queue having a name identical to the second name in the client socket interface, in response to a connection command from the client application for connection to the server socket interface,
wherein the server message queue and the client message queue perform message queue-based communication between the server application and the client application.
